(19) United States
(12) Patent Application Publication
(10) Pub. No.: US 2008/0169318 A1
(43) Pub. Date: Jul. 17, 2008

(54) Stopper Device for Controlling a Flow of Moten Metal

(75) Inventors: Manfred Winkelmann, Krefeld (DE); Erika Winkelmann, Krefeld (DE); Markus Fauhl, Langerwehe (DE); Jurgen Pernot, Monchengladbach (DE); Helmut Muller, Krefeld (DE); Stephen Lee, Cardross (GB)

Correspondence Address: WALKER & JOCKE, L.P.A., 231 SOUTH BROADWAY STREET, MEDINA, OH, 44256, US

(73) Assignee: REFRACTORY INTELLECTUAL PROPERTY GMBH & CO. KG, Wien (AT)

(21) Appl. No.: 11/913,089

(22) PCT Filed: Apr. 24, 2006
(86) PCT No.: PCT/EP2006/003744

§ 371 Date: Oct. 30, 2007

(30) Foreign Application Priority Data
May 19, 2005 (EP) 05010807.5

(51) Int. Cl. B22D 41/14; B23P 6/00

(52) U.S. Cl. 222/597; 29/402.06

(57) ABSTRACT

A stopper device for controlling a flow of molten metal at an outlet opening of a metallurgical vessel, said device comprising: a) a rod like body (12) with a longitudinal axis (A) and made of a refractory ceramic material, b) an elongated bore hole (14) extending from an upper surface of said body (12) towards its opposite lower end, wherein c) said bore hole (14) being equipped, at least at its portion adjacent the lower end of the body (12), with at least one fixing means (16) adapted to receive corresponding fixing means (18) of a refractory ceramic part (20, 22, 38) to be fixed at the lower end of the body (12).

The invention relates to a stopper device for controlling a flow of molten metal at an outlet opening of a metallurgical vessel, such as a tundish.

It is well known in steel casting to employ such a stopper rod, which is in many cases a one-piece-stopper rod, moved vertically by the use of a lifting mechanism in order to vary the cross-sectional area of an outlet opening of the corresponding metallurgical vessel.

Stopper rods have also been used to introduce a gas, such as an inert gas, i.a. argon, into the molten steel for removing non-metallic inclusions from the molten melt.

In all cases the stopper device must withstand hours submerged in molten metal. It must also be capable of enduring the harsh thermal shock encountered on the start-up of casting and any mechanical forces imposed to it.

Insofar many attempts have been made to improve the mechanical and thermal properties of such a stopper device and to improve its behaviour during use.

Typically a stopper rod has a so called nose portion at its lower end, which serves to seal the corresponding outlet opening of the metallurgical vessel when the stopper rod is at its lowest position or to open the outlet nozzle after the stopper rod has been lifted vertically.

Insofar it is not surprising that this nose portion defines that part of the stopper device with the highest degree of wear. The whole stopper rod must be replaced after a certain time of use, although just its lower end portion (the nose portion) being worn to an extent which requires replacement.

Such replacement causes corresponding replacement time and costs.

Attempts have been made to provide a stopper rod with a nose portion of a ceramic material of improved resistance to wear. Indeed such a mono-block stopper rod made of two different ceramic materials increases its lifetime but causes relatively high production costs and technical difficulties in view of different thermal expansions during treatment under different temperatures in use.

It is therefore an object of the present invention to provide a stopper device for flow control of molten metal from a vessel, which avoids the above-mentioned disadvantages and reduces the steel production costs.

The invention starts from a conventional stopper rod having a rod like body (with a longitudinal axis A) and made of a refractory ceramic material, which further comprises an elongated bore hole, extending from an upper surface of said body to its lower end. It is conventional to provide within said borehole, mostly in its first third of its length (from up to down) means for fixing one end of a corresponding metal rod, which other end is attached to the lifting mechanism. Possible constructions of such fixing means may be taken from prior art, for example from EP 0 358 535 B2 and the prior art mentioned in said European patent, all of which disclosure is made part of the disclosure of the present description.

The inventive idea focuses on the lower end portion of the stopper device, which undergoes the strongest mechanical and thermal attacks during use.

The invention does not amend the surface and/or material of the lower end portion but provides within the (lower) end portion of said bore hole at least one (further) fixing means adapted to receive corresponding fixing means of a refractory ceramic part to be fixed to the lower end of the body.

While the fixing means in the upper part of the bore hole serve to hold the corresponding metal rod the function of the fixing means at the lower end of the bore hole are completely different. They are designed to fit with a correspondingly designed portion of a refractory ceramic part which provides the corresponding end portion of the stopper rod, in many cases the nose portion.

There exist several lines of embodiment fulfilling the criteria mentioned above:

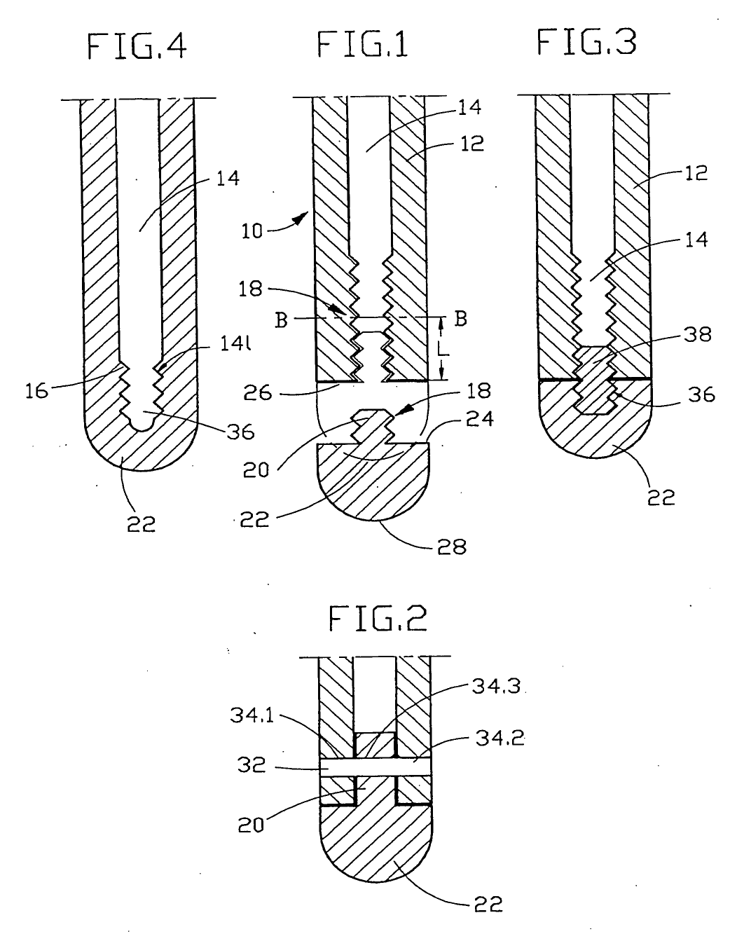

A first group is characterized by an open lower end of said bore hole, as shown in attached FIG. 1. The lower end part of the bore hole is equipped with a threaded wall portion which fits with an outer threaded portion of rod like extension of said nose portion to be mounted. Accordingly the (replacement) nose portion is simply screwed into the lower end of the bore hole. As will be further explained in connection with the drawings the nose portion should have an outer shape which corresponds to the outer shape of the ceramic stopper body so as to provide a continuous smooth surface all over the length of the stopper rod.

Instead of providing corresponding threads other fixing means may be provided along said lower bore hole end and the replacement part respectively. For example the replacement nose section may be fixed to the stopper body by providing corresponding bore holes more or less perpendicular to the longitudinal axis of the stopper rod and a corresponding ceramic pin running through said bore holes. Such an embodiment is shown as well in the attached drawings (FIG. 2).

When said separate nose portion must be replaced (again) it may simply be detached from the stopper rod the other way round as described before and a new nose portion may be fixed to the stopper rod.

If the nose portion may not be detached anymore and/or the adjacent lower end of the stopper body must as well be replaced the invention provides the possibility to simply cut off the lower (worn) part of the stopper body, possibly together with the integrated used nose portion. Obviously the rod is cut along the section, comprising the fixing means, so that fixing means being present in the remaining part to be used again.

This makes the stopper rod shorter. In order to avoid lowering of the lifting mechanism which is not always easily possible, the further replacement nose portion may then have a greater length than the one replaced. This replacement operation may be performed to its best if the new nose portion has a length which provides together with the cut remaining stopper body a total length identical to the length of the original stopper device.

The second group of embodiment comprises stopper rods with a central bore hole ending at a distance to the lowermost surface section of the lower end of the stopper rod (i.e. the lower end of the nose portion). Such a stopper rod may be used as it is. After a certain degree of wear along the nose portion has been observed the worn nose portion is cut off at an axial length of the stopper rod to provide an open lower end of the central bore hole. Again this cutting line is chosen such that the bore hole is provided in this area with the said fixing means adapted to receive corresponding fixing means of a refractory ceramic part to be fixed at this now provided lower end of the body. After the worn nose portion has been cut off the design of this stopper rod is similar to the design of the stopper rod according to the first embodiment mentioned above. Further cut-offs and replacements may be affected as described before.

It is possible to make the whole stopper rod of one refractory ceramic material. It is also possible to use different materials for the replacement parts (nose portions) and the remaining stopper body. It is further possible to provide sealing means between the lower surfaces of the stopper rod and the corresponding surfaces of the replacement parts. Such sealing means must withstand the high temperatures being effective at this area. Graphite sealing means are suitable in this respect.

The fixing means at the lower end of the bore hole may extend about ⅓ of the total length of the stopper device but they may be provided as well along the total length of the bore hole.

If the bore hole ends shortly before the lower free end of the body the stopper rod may be used without any further manipulations. The closed lower part of the stopper rod provides the so called nose portion. It may be possible to provide said nose portion with at least one gas channel, one end of which opens into the corresponding lower end of the bore hole and the other end of which merges into a lower most surface portion of the lower end of the body.

This gas channel may be present as well in any of the above-mentioned replacement parts which makes it possible to continuously use said reconstructed stopper rod for gas purging purposes.

As described above the invention also comprises a process for reconstructing a stopper device as described before in two different embodiments: If the stopper device is provided with a nose portion at its lower end, i.e. closed at its lower end, the reconstruction starts by cutting off the used nose portion at a distance from the lower free end of the body so that at least one fixing means remains along the remaining lower end of the bore hole and fixing a new nose portion along the at least one fixing means along the remaining lower end of the bore hole.

This replaced nose portion should be preferably of a greater length than the one replaced in order to keep the length of the whole stopper rod constant.

If a stopper device is used to which no nose portion is yet fitted or which is equipped with a separate nose portion at its lower end the reconstruction steps start by loosening the said used nose portion from the remaining body or cutting off the used nose portion at a distance to the lower free end of the body, so that at least one fixing means remains along the remaining lower end of the bore hole, before fixing a new nose portion along the at least one fixing means at the remaining lower end of the bore hole.

Further features of the invention are described in the subclaims and the other application documents.

The invention will now be described in more detail with reference to the attached schematic figures, showing three different embodiments of a stopper rod according to the invention.

FIG. 1 shows the lower end (about 20% of the total length) of a stopper rod 10 which is characterized by a ceramic refractory body 12 of an elongated rod shape, which longitudinal axis is depicted by A-A.

A central bore hole 14 is running through said body 12, coaxially to said axis A-A.

The lower end part of the bore hole 14 is provided with a threaded wall portion 16. A corresponding thread 18 is provided at the outer circumferential surface of a protruding part 20 of a ceramic refractory nose portion 22 which may be screwed into said threaded wall portion 16 in order to provide a ready to use stopper rod. When the nose portion 22 is fully screwed into bore hole 14 an outer shoulder 24 of the nose portion 22 abuts against a corresponding lower surface portion 26 of body 12. Between these two corresponding surfaces 24, 26 a refractory gasket, for example made of graphite, may be placed.

In FIG. 1 the design of the assembled stopper rod is shown in dotted lines.

When the nose portion 22 has undergone serious wear and must be replaced it may be screwed off or the stopper rod may be cut at a distance from its lower end, schematically shown in FIG. 1 by line B-B. Thereafter a new nose portion 22 may be placed within the remaining threaded wall portion 16 as described before. If the total length of the stopper rod should be the same as before the new nose portion 22 must have a length between its shoulder 24 and its lower most point (surface area) 28 of the previously replaced nose portion plus L, i.e. the distance between the surface portion 26 and cutting line B.

The embodiment shown in FIG. 2 is similar to that of FIG. 1, but the nose portion 22 is fixed to stopper rod body 12 by a pin 32, which is fed into corresponding bore holes 34.1, 34.2 within said refractory body 12 and 34.3 within the protruding part 20 of nose portion 22.

A third embodiment is shown in FIG. 3 which resembles the one of FIG. 1. Instead of a protruding part 20 the nose portion 22 is provided with a recess 36 of the same diameter as the bore hole 14. Again the threaded wall of the recess 36 corresponds to the threaded walls of the bore hole 14 so that the nose portion may be fixed to the stopper body 12 by means of an intermediate pin 38 with a corresponding outer thread.

A fourth version is shown in FIG. 4. The stopper rod shown is a ready to use stopper rod, i.e. it includes a nose portion 22 and is manufactured as the mono-block stopper rod.

Nevertheless it is of a complete different construction compared with common stopper rods as the bore hole 14 is provided at its lower end 141 with a threaded wall portion 16, extending up to or even into the nose portion 22.

According to prior art a stopper rod had to be thrown away and replaced by a completely new device even in cases where only the nose portion 22 had been worn to a certain extent.

Now the nose portion 22 may be cut off, as explained in connection with the embodiment of FIG. 1 and a new nose portion 22 like that of FIG. 1 may be attached to the remaining stopper body 12.

Typically the axial length of the nose portion—according to prior art—is between 80 and 120 mm. Its outer diameter will typically be 100 to 150 mm. The fixing means may extend at least along 20% of the total axial length of the bore hole.

1. A stopper device for controlling a flow of molten metal at an outlet opening of a metallurgical vessel, said device comprising:
a) a rod like body (12) with a longitudinal axis (A) and made of a refractory ceramic material,
b) an elongated bore hole (14) extending from an upper surface of said body (12) towards its opposite lower end, wherein
c) said bore hole (14) being equipped, at least at its portion adjacent the lower end of the body (12), with at least one fixing means (16) adapted to receive corresponding fixing means (18) of a refractory ceramic part (20, 22, 38) to be fixed at the lower end of the body (12).

2. Stopper device according to claim 1, comprising fixing means (16) at the lower end of the bore hole (14) adapted to receive a threaded portion (18) of the part (20) to be fixed or a threaded bolt (38) interconnecting the body (12) and the part (22) to be fixed.

3. Stopper device according to claim 1, wherein said fixing means (16) at the lower end of the bore hole (14) are provided by a threaded portion of said bore hole (14).

4. Stopper device according to claim 1, wherein said fixing means (16) at the lower end of the bore hole (14) extend about less than ⅓ of the total length of the stopper device.

5. Stopper device according to claim 1, wherein said bore hole (14) ends shortly before the lower free end (28) of the body (12).

6. Stopper device according to claim 1, wherein said bore hole (14) extends into a nose portion (22), providing the lower end of the body (12).

7. Stopper device according to claim 1, wherein said lower end of said body (12) is provided with at least one gas channel, one end of which opens into the corresponding lower end of the bore hole (14) and the other end of which merging into a lowermost surface portion (28) of the lower end of the body (12).

8. Stopper device according to claim 1, wherein the refractory ceramic part (22) to be fixed at the lower end of the body (12) is a nose portion of said stopper device.

9. Process for reconstructing a stopper device according to anyone of claims 1 to 8 after use, which stopper device being provided with a nose portion at its lower end, comprising the following steps:
a) cutting off the used nose portion at a distance to the lower free end of the body, so that at least one fixing means remains along the remaining lower end of the bore hole,
b) fixing a new nose portion along the at least one fixing means at the remaining open lower end of the bore hole.

10. Process according to claim 9, wherein a new nose portion is used which has an axial length so that the overall length of the reconstructed stopper device remains unchanged to its original length.

11. Process for reconstructing a stopper device to anyone of claims 1 to 8 after use, which stopper device being equipped with a separate nose portion at its lower end, comprising the following steps:
a) loosening of said used nose portion from the remaining body, or
b) cutting off the used nose portion at a distance to the lower free end of the body, so that at least one fixing means remains along the remaining open lower end of the bore hole, and
c) fixing a new nose portion along the at least one fixing means at the remaining open lower end of the bore hole.
